(19) United States
(12) Patent Application Publication
(10) Pub. No.: US 2011/0084520 A1
(43) Pub. Date: Apr. 14, 2011

(54) Method and apparatus for component alignment and elimination of tacking in a welding process

(76) Inventors: Timothy D. Stetler, Blandon, PA (US); Michael D. Snook, Bernville, PA (US); Robert J. Mills, III, Womelsdorf, PA (US)

(21) Appl. No.: 12/798,318

(22) Filed: Apr. 1, 2010

Related U.S. Application Data
(60) Provisional application No. 61/165,977, filed on Apr. 2, 2009.

(51) Int. Cl. B62D 25/00; B23K 31/02

(52) U.S. Cl. 296/193.01; 228/101

(57) ABSTRACT

An improved apparatus and method of joining two metallic components prior to making a full seam weld is disclosed. A first inner structural metallic component has at least one neutral zone, an inner surface, an outer surface and an aperture located in the neutral zone. A second outer structural metallic component has at least one neutral zone, an inner surface, an outer surface and a dimple with a raised portion on the inner surface and a recessed portion on the outer surface. The method uses the steps of joining the first and second metallic components so that the first component outer surface and the second component inner surface are directly adjacent each other, and joining the two structural metallic components by forming a full seam weld between the two components.

### RELATED APPLICATION

This patent application is a non-provisional patent application based on U.S. patent application Ser. No. 61/165,977, filed Apr. 2, 2009, from which priority is claimed and which is incorporated by reference in its entirety.

### FIELD OF THE DISCLOSURE

The present disclosure relates to an apparatus and an improved method for manufacturing a welded sub-assembly of two or more components, such as a side rail, a cross member, or a bracket for use in a vehicle frame assembly.

### BACKGROUND OF THE DISCLOSURE

Traditionally, manufacturing a welded sub-assembly has required providing two or more structural metallic components and precisely positioning these components in a desired orientation relative to one another. This can be achieved by, for example, supporting the structural metallic components on a fixture. Then, while the components are being maintained in the desired orientation, a tack welding process is performed to preliminarily secure the components together. Tack welding allows the components to be removed from the fixture without losing their desired relative orientation. Thereafter, a final welding process is performed to permanently secure the components together to form the final sub-assembly. Although this method is effective, it has been found to be relatively inefficient because it requires two different welding processes.

It would thus be desirable to provide an apparatus and an improved method for manufacturing a welded sub-assembly by eliminating the need to tack weld structural metallic components prior to making a final weld.

### SUMMARY OF THE DISCLOSURE

The present disclosure is directed to an apparatus and an improved method of joining two metallic components prior to making a full seam weld. A first inner structural metallic component comprises at least one neutral zone, an inner surface, an outer surface and an aperture located in the neutral zone. A second outer structural metallic component comprises at least one neutral zone, an inner surface, an outer surface and a dimple comprising a raised portion on the inner surface and a recessed portion on the outer surface.

The method uses the steps of joining the first and second metallic components so that the first component outer surface and the second component inner surface are directly adjacent each other, wherein the first component aperture is in axial alignment with the second component dimple. The two structural metallic components are joined by forming a full seam weld between the two components.

### BRIEF DESCRIPTION OF THE DRAWING

The advantages of the present disclosure will become readily apparent to those skilled in the art from the following detailed description when considered in light of the accompanying drawings in which:

FIG. 1 is a perspective view of the structural metallic components prior to joining in accordance with the method of the present disclosure;

FIG. 2 is a perspective view of the joined structural metallic components in accordance with the method of the present disclosure;

FIG. 3 is a cross-sectional view of the structural metallic component sub-assembly in accordance with the method of the present disclosure; and

FIG. 4 is a detailed view of the inset of FIG. 1.

### DETAILED DESCRIPTION OF THE PREFERRED EMBODIMENTS

It is to be understood that the disclosure may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions, or other physical characteristics relating to the embodiments disclosed are not to be considered as limiting, unless expressly stated otherwise. Additionally, although the disclosure will be described in connection with structural automotive frame components, it would be understood by one of ordinary skill in the art that the method for use and apparatus described herein has applications to other processes or components utilizing tack welding prior to making a full seam weld.

The present disclosure comprises providing a first structural metallic component 10 and a second structural metallic component 12. Each structural metallic component 10, 12 is preferably a structural metallic automotive component such as a side rail, a cross member, or a bracket for use in a vehicle frame sub-assembly. The first structural metallic component 10 may be an inner component and the second structural metallic component 12 may be an outer component. Also, one skilled in the art would recognize that the present disclosure may be practiced with a plurality of first structural metallic components and a plurality of second structural metallic components.

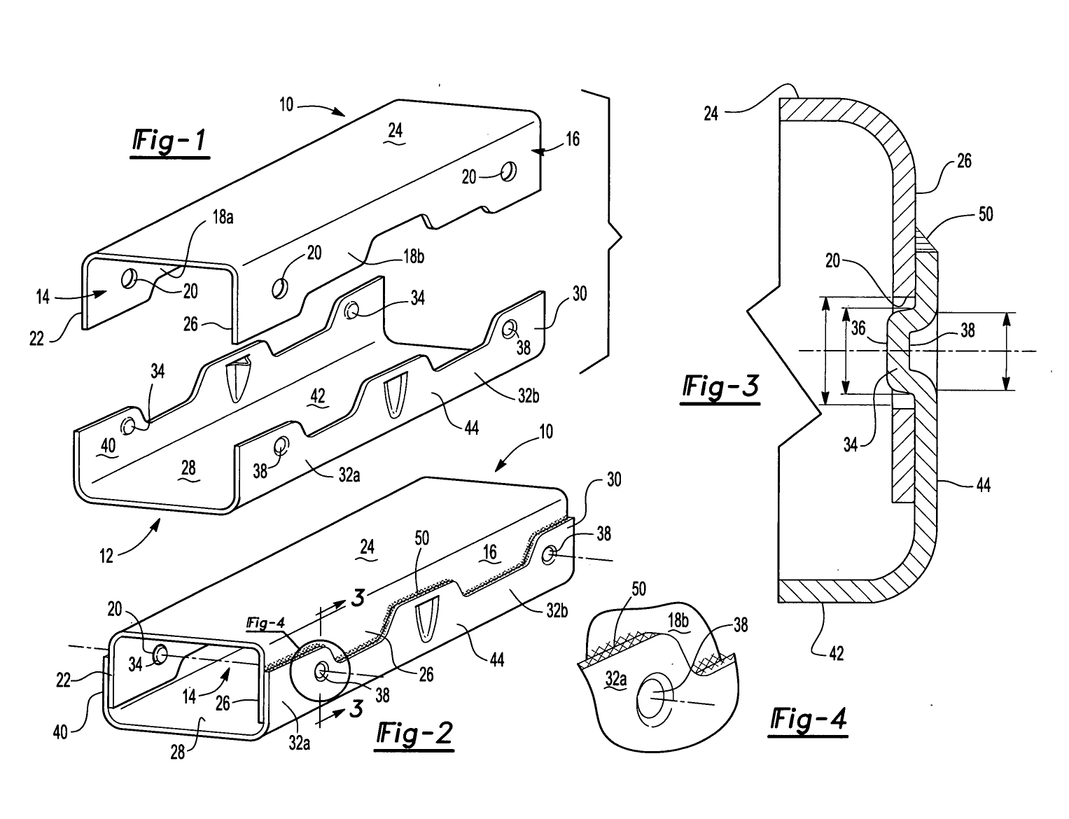

As shown in FIG. 1, the first structural metallic component 10 comprises an inner surface 14 and an outer surface 16. The first structural metallic component 10 also comprises at least one neutral zone, and as shown in FIG. 1 there may be multiple neutral zones 18a, 18b. For the purposes of the present disclosure, a neutral zone is defined as an area in the structural metallic component which does not affect the performance, durability, and/or safety of the sub-assembly after performing the final welding operation that joins the two components. An aperture 20 is located within a neutral zone 18a, 18b. As shown in FIG. 3, the aperture 20 may have a constant diameter. However, the aperture 20 need not have a constant diameter to practice the present disclosure.

In the embodiment, the first structural metallic component 10 comprises a first flange portion 22, an intermediate portion 24, and a second flange portion 26. The first flange portion 22 and the second flange portion 26 are each attached to opposite ends of the intermediate portion 24 and are parallel to each other and perpendicular to intermediate portion 24. In this embodiment, the first flange portion 22, the intermediate portion 24, and second flange portion 26 comprise the inner surface 14 and the outer surface 16. The first flange portion 22 and the second flange portion 26 are also comprised of at least one neutral zone 18. Additionally, within a neutral zone 18a, 18b the aperture 20 extends from the inner surface 14 to the outer surface 16.

The second structural metallic component 12 also comprises an inner surface 28 and an outer surface 30. The second structural metallic component 12 further comprises at least one neutral zone, and as shown in FIG. 2 there may be multiple neutral zones 32a, 32b. A dimple 34, is located within the neutral zone 32a, 32b. As shown in FIGS. 3 and 4, the dimple 34 comprises a raised portion 36 on the inner surface 28 and a recessed portion 38 on the outer surface 30 of the second structural metallic component 12. The diameter of the raised portion 36 is larger than the diameter of the recessed portion 38. Also, as shown in FIGS. 3 and 4, the raised portion 36 and the recessed portion 38 may be concentric.

The dimple 34 may be formed in an embossing process using a die structure. One skilled in the art would recognize that each structural metallic component may have more than one neutral zone. Thus, the second structural metallic component 12 may have a plurality of dimples 34 and the first structural metallic component 10 may have a plurality of apertures 20. Since the second structural metallic component 12 may have a plurality of neutral zones 32a, 32b, it is preferable that when choosing which neutral zone(s) to form a dimple in, that the placement occur so that the effect on the second structural metallic components 12 integrity is unaffected or at least is minimized.

In the embodiment, the second structural metallic component 12 comprises a first flange portion 40, an intermediate portion 42, and a second flange portion 44. The first flange portion 40 and the second flange portion 44 are each attached to opposite ends of the intermediate portion 42 and are parallel to each other and perpendicular to the intermediate portion 42. In this embodiment the first flange portion 40, the intermediate portion 42, and second flange portion 44 comprise the inner surface 28 and the outer surface 30. The first flange portion 40 and the second flange portion 44 are comprised of at least one neutral zone 32a, 32b. The dimple 34, comprising a raised portion 36 on the inner surface 28 and a recessed portion 38 on the outer surface 30, is located within the at least one neutral zone 32.

The embodiment shown in FIGS. 1 and 2 depicts the aperture 20 in neutral zones 18a, 18b of the first structural metallic component 10 and the dimple 34 in a neutral zone 32a, 32b of the second structural metallic component 12, however the at least one dimple 34 may be located in a first structural metallic component neutral zone 18a, 18b and the at least one aperture 20 may be located in a second structural metallic component neutral zone 32a, 32b. In another embodiment where both the first structural metallic component 10 and the second structural metallic component 12 have more than one neutral zone 18a, 18b, 32a, 32b, at least one dimple 34 and at least one aperture 20 may be positioned on a single component in separate neutral zones.

As shown in FIG. 2, the present disclosure may further comprise joining the first and the second structural metallic components 10, 12 so that the first structural metallic component outer surface 16 and the second structural metallic component inner surface 28 are directly adjacent to each other. In an embodiment, at least one first structural metallic component neutral zone 18a, 18b is directly adjacent a second structural metallic component neutral zone 32a, 32b so that at least one second structural metallic component dimple 34 extends through at least one first structural metallic component aperture 20.

Thus, in this embodiment, the diameter of the dimple raised portion 36 is smaller than the diameter of the aperture 20. Additionally, the first structural metallic component aperture 20 may be in axial alignment with the second structural metallic component dimple 34. This allows the at least one second structural metallic component dimple 34 and the at least one first structural metallic component aperture 20 to provide cooperating positioning structures that prevent relative movement between the structural metallic components 10, 12. As shown in FIGS. 2 and 3, after joining the first structural metallic component 10 with the second structural metallic component 12, at least one dimple 34 may extend through at least one aperture 20 of the first structural metallic component inner surface 14.

The present disclosure also may comprise forming a final weld 50 which is preferably a full seam weld between the structural metallic components 10, 12. The full seam weld permanently secures the components together to create the final sub-assembly. However, it should be noted that the present disclosure may also comprise preventing the relative movement of the structural metallic components 10, 12 by locking the first structural metallic component 10 and the second structural metallic component 12 by the engagement of at least one aperture 20 and at least one dimple 34 prior to forming the full seam weld.

Thus, the present disclosure provides an improved method for manufacturing a welded sub-assembly of two or more structural metallic components. The present disclosure has also been found to eliminate the need to tack weld two or more structural metallic components prior to forming a full seam weld between them. Additionally, prior to performing the seam weld, the cooperating positioning structures are provided at locations such that when the components are positioned in the desired orientation the positioning structures engage one another to prevent relative movement between the structural metallic components.

In accordance with the provisions of the patent statutes, the present disclosure has been disclosed in what are considered to represent its preferred embodiments. However, it should be noted that the disclosure can be practiced otherwise than as specifically illustrated and described without departing from its spirit or scope.

What is claimed is:

1. A method of joining two metallic components prior to making a full seam weld comprising:
providing a first inner structural metallic component comprising at least one neutral zone, wherein said first component has an inner surface and an outer surface and an aperture in said neutral zone extending from said inner surface to said outer surface;
providing a second outer structural metallic component comprising at least one neutral zone, wherein said second component has an inner surface and an outer surface, wherein said neutral zone has a dimple comprising a raised portion on said second component inner surface and a recessed portion on said second component outer surface;
joining said first and said second metallic components so that said first component outer surface and said second component inner surface are directly adjacent each other, said first component neutral zone is directly adjacent said second component neutral zone, and wherein said first component aperture is in axial alignment with said second component dimple and said dimple extends through said aperture; and
forming a full seam weld between said first and said second components.

2. The method defined in claim 1, wherein said first and said second structural components each have at least two neutral zones and cooperating apertures and dimples.

3. The method defined in claim 1, further comprising interlocking said first and said second structural components.

4. The method defined in claim 1, wherein said aperture has a constant diameter.

5. The method defined in claim 1, wherein said dimple extends through said aperture of said first structural component inner surface.

6. The method defined in claim 1, wherein said dimple is formed by embossing.

7. The method defined in claim 1, wherein said first structural component and said second structural component are structural automotive metallic components comprising at least a pair of either side rails, cross members, or brackets.

8. The method defined in claim 1, wherein said raised dimple portion on said second structural component inner surface has a diameter and said recessed dimple portion on said second structural component outer surface has a diameter, wherein said diameter of said raised dimple portion is larger than said diameter of said recessed dimple portion.

9. The method defined in claim 8, wherein said aperture diameter is larger than said raised dimple portion diameter.

10. A method of joining two structural metallic automotive components prior to making a full seam weld comprising:
providing a first inner structural component comprising a first flange portion, an intermediate portion, and a second flange portion wherein said first flange, intermediate, and second flange portions have an inner surface and an outer surface, wherein said first flange portion and said second flange portion are parallel to each other and perpendicular to said intermediate portion and said first flange portion and said second flange portion have at least one neutral zone, and wherein each said neutral zone on each flange portion has an aperture extending from said inner surface to said outer surface;
providing a second outer structural component comprising a first flange portion, an intermediate portion, and a second flange portion wherein said first flange, intermediate, and second flange portions have an inner surface and an outer surface, wherein said first flange portion and said second flange portion are parallel to each other and perpendicular to said intermediate portion and said first flange portion and said second flange portion have at least one neutral zone, and wherein each said neutral zone has a dimple comprising a raised portion on said flange portions inner surfaces and a recessed portion on said flange portions outer surfaces;
joining said first inner and said second outer structural components so that said first inner component first flange portion outer surface is directly adjacent said second outer component first flange inner surface and said first component second flange portion outer surface is directly adjacent said second outer component first flange inner surface, wherein said first and second flange portions at said neutral zones are directly adjacent said second component neutral zone, and wherein said first component aperture is in axial alignment with said second component dimple and said dimple extends through said aperture; and
forming a full seam weld between said first and said second components.

11. An automotive vehicle frame sub-assembly comprising, a first inner structural component comprising a first flange portion, an intermediate portion, and a second flange portion wherein said first flange portion, intermediate portion, and second flange portion have an inner surface and an outer surface, said first flange portion and said second flange portion have at least one neutral zone, and wherein said neutral zone on each flange portion has an aperture extending from said inner surface to said outer surface;
a second outer structural component comprising a first flange portion, an intermediate portion, and a second flange portion wherein said first flange portion, intermediate portion, and second flange portion have an inner surface and an outer surface, and said second flange portion have at least one neutral zone, and wherein said neutral zone has a dimple; and
wherein said first structural metallic component is connected to said second structural metallic component so that said first inner component first flange portion outer surface is directly adjacent said second outer component first flange inner surface and said first component second flange portion outer surface is directly adjacent said second outer component first flange inner surface, wherein said first and second flange portions' neutral zones are directly adjacent said second component neutral zone, and wherein said first component aperture is in axial alignment with said second component dimple and said dimple extends through said aperture.

12. An automotive vehicle frame sub-assembly according to claim 11, wherein said first flange portion and said second flange portion of said first structural metallic component are parallel to each other and perpendicular to said intermediate portion.

13. An automotive vehicle frame sub-assembly according to claim 11, wherein said first flange portion and said second flange portion of said second structural metallic component are parallel to each other and perpendicular to said intermediate portion and said first flange portion

14. An automotive vehicle frame sub-assembly according to claim 11, wherein said dimple comprises a raised portion on said flange portions inner surfaces and a recessed portion on said flange portions outer surfaces of said second structural metallic component.
